(19) United States
(12) Patent Application Publication
(10) Pub. No.: US 2002/0011908 A1
(43) Pub. Date: Jan. 31, 2002

(54) Circuit breaker with electro-magnetic trip apparatus

(76) Inventors: Cheon-Youn Kim, Yeonsu-gu (KR); Jeong-Wan Kim, Bucheon-si (KR)

Correspondence Address: RABIN & CHAMPAGNE, PC, 1101 14TH STREET, NW, SUITE 500, WASHINGTON, DC, 20005, US

(21) Appl. No.: 09/865,487

(22) Filed: May 29, 2001

(30) Foreign Application Priority Data
May 30, 2000 (KR) 2000-29349

(51) Int. Cl. H01H 75/12

(52) U.S. Cl. 335/35

(57) ABSTRACT

A circuit breaker for interrupting an electric circuit in detection of an overcurrent exceeding a rated value, said circuit breaker comprising: detection means for detecting the flow of an overcurrent exceeding a predetermined rated value in said electric circuit from the bending of a bimetal, and creating a detection signal; control means for sending an tripping signal in response to the detection signal from said detection means; and trip means being electro-magnetically operated in response to the tripping signal from said control means to interrupt said electric circuit. According to the circuit breaker, fabrication of the bimetal and the armature is easy and productivity in fabrication of the circuit breaker is increased. Also, a precise and rapid tripping can be carried out when overcurrents takes place. Furthermore, the time required for the time-lag tripping is reduced due to the rapid tripping and thus the degradation of the covering material can be reduced.

### BACKGROUND OF THE INVENTION

The invention relates to a circuit breaker for interrupting an electric circuit in the detection of an overcurrent exceeding a rated value, and more particularly to a circuit breaker for interrupting an electric circuit in the detection of an overcurrent exceeding a rated value in which the detection of a predetermined overcurrent and following shut-off operation of an electric circuit may be carried out electro-magnetically.

In general, circuit breakers for electric lines in houses are used to prevent any electricity induced fires from taking place. The circuit breaker for an electric line is adapted to interrupt an electric circuit when electric currents in use exceed a rated value while a load is being applied, or when any instantaneous overcurrent takes place.

In the case of persistent low levels of overcurrent, the overcurrent heats a circuit breaker while passing through it, and thus a bimetal within the circuit breaker bends due to the heat. Bending of the bimetal also flexes an armature which is integrally attached to the bimetal. The flexed armature is separated from a latching means into which the armature is engaged and thus causes a trip mechanism to operate. Then, an electric circuit within the circuit breaker is interrupted, thereby interrupting the whole electric circuit. Such an interruption is referred to time-lag tripping. In time-lag tripping, an electric circuit is regulated to be shut off within 1 hour under the overcurrent of about 135% of a normal alternating current, and within 4 minutes under about 200%.

In the case of a phase-to-phase short caused by a motor tool or a metal object at the load side, a higher level of instantaneous overcurrent takes place. The overcurrent magnetizes a magnetic yoke within the circuit breaker to attract the armature thereby interrupting the electric circuit. The magnetic yoke, which is provided around the bimetal in the form of a stationary iron core, can be magnetized instantly on any overcurrent to interrupt an electric circuit within a very short time. Therefore, such an interruption is referred to as instantaneous tripping.

The foregoing two types of trippings, i.e., time-lag tripping and instantaneous tripping are widely adapted to conventional circuit breakers for electric lines. These types of trippings are disclosed in various documents including U.S. Pat. No. 4,080,582 entitled “Circuit Breaker with Improved Trip Mechanism.”

The foregoing time-lag tripping which uses a bimetal, however, may have the following problems:

First, it is required to arrange a bimetal and an armature within a circuit breaker as combined in a predetermined angle relative to each other, so that the armature may bend as the bimetal bends and thus being released from engagement with the latching means. However, there may be disadvantages that a very precise operation is required to form this arrangement, and that the bimetal and the armature also may not carry out the desired precise cooperation even though arranged as above.

Second, the bimetal is induced to bend by heat produced in the electric circuit or the electric line by an overcurrent. Therefore, the electric line is continuously exposed to heat until the electric circuit is interrupted by a time-lag tripping.

In particular, the time-lag tripping requires a high temperature state to be continued for more than a predetermined amount of time, thereby causing the electric line to be heated for a long time. Covering material of the electric line undergoes thermal degradation when the high temperature state takes place repeatedly. This thermal degradation is caused when the covering material is heated for a long time, and thus the covering material loses its own characteristics. The electric line then has a very weak physical state or fragility to any outer impact, and also tends to generate arc thereby causing fire. In short, the mechanical tripping method of the prior art based on the bending of the bimetal and the armature coupled thereto suffers from thermal degradation of the covering material and thus makes electric line structure frail.

To solve the foregoing problems, a circuit breaker which can perform tripping in a relatively lower overcurrent to interrupt an electric circuit is proposed in documents such as U.S. Pat. No. 4,933,653 entitled “Circuit breaker with low current magnetic trip”. In the foregoing document, it is disclosed, trip means which comprises a supplemental bimetal and armature so that tripping can be carried out in a lower overcurrent to improve workability. However, even in the foregoing arrangement, it is very difficult to precisely arrange the bimetal and the armature so that they can cooperate to perform tripping. Also, it is hardly expected that the bimetal and the armature can perform a precise operation as desired even when arranged as above. Furthermore, this tripping also requires a certain amount of lag time so that the problem of the electric line and the covering material thereof may be heated and thus degraded.

### SUMMARY OF THE INVENTION

Considering the foregoing problems, it is an objective of the invention to provide a circuit breaker which has a bimetal and an armature arranged as separated, and electro-magnetically performs overcurrent detection, tripping control and tripping operation.

It is another object of the invention to provide a circuit breaker which can be electro-magnetically operated, thereby preventing degradation of the covering material of the electric line due to any mechanical time-lag tripping.

According to an embodiment of the invention to obtain the foregoing objects, it is provided a circuit breaker for interrupting an electric circuit in detection of an overcurrent exceeding a rated value, the circuit breaker comprising: detection means for detecting the flow of overcurrent exceeding a predetermined rated value in the electric circuit from the bending of a bimetal, and creating a detection signal; control means for sending an tripping signal in response to the detection signal from the detection means; and trip means being electro-magnetically operated in response to the tripping signal from the control means to interrupt the electric circuit.

The trip means may comprise a stationary contact; rotation means provided with a movable contact which can be butted with the stationary contact; latch means engaged into the rotation means for rotating the rotation means; an armature for gripping the latch means; a solenoid being operated in response to the tripping signal from the control means; and trigger means detachably engaged into the armature for drawing the armature in response to the operation of the solenoid.

### BRIEF DESCRIPTION OF THE DRAWINGS

The foregoing objects and other advantages of the invention will be more apparent by describing in detail the preferred embodiments thereof with reference to the accompanying drawings, in which;

FIG. 1 to FIG. 4 are plane views of a circuit breaker of the invention with the cover thereof being removed for illustrating steps of electromagnetic tripping;

FIG. 5 is a perspective view of an armature and a latching mechanism in use for the circuit breaker of the invention;

FIG. 6 is an exploded perspective view for illustrating relations among a solenoid, a trigger mechanism and an armature in use for the circuit breaker of the invention;

FIG. 7 is a block diagram for illustrating a concept of the circuit breaker of the invention;

FIG. 8 is a circuit diagram of the circuit breaker of the invention;

FIG. 9 is an exploded perspective view of a part of the circuit breaker shown in FIG. 1;

FIG. 10A is a plane view for illustrating an arc quencher of the invention;

FIG. 10B is a perspective view of a grid in use for the arc quencher of the invention;

To FIG. 11A is a bottom view of a bimetal-magnetic yoke assembly of the invention;

FIG. 11B is a vertical sectional view taken in I-I line of FIG. 11a;

FIG. 11C is a vertical sectional view similar to FIG. 11b, which is taken from another example of a bimetal-magnetic yoke assembly of the invention; and

FIG. 12 is a vertical sectional view of a bimetal-magnetic yoke assembly of the prior art.

### DETAILED DESCRIPTION OF THE INVENTION

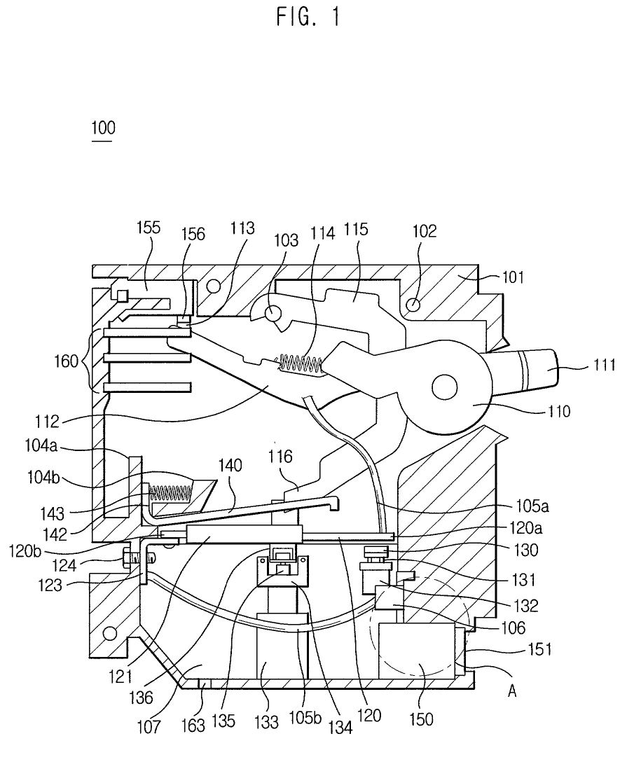

FIG. 1 to FIG. 4 are plane views of a circuit breaker of the invention with the cover thereof being removed for illustrating steps of electromagnetic tripping. Basic arrangement of the circuit breaker of the invention will be understood with reference to FIG. 1 to FIG. 4.

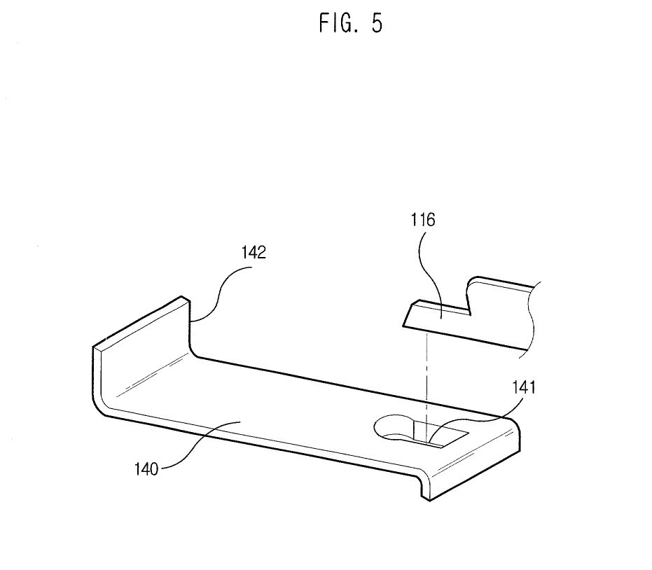

The reference numeral 100 indicates a circuit breaker of the invention. The circuit breaker 100 has a housing 101, which is made with an insulating material with resistance to impact and heat such as high strength plastic. A plurality of screw holes 102 are provided in the section of the housing 101 for fixing a cover(not shown) to be coupled to the same. At the upper right side of the housing 101, a rotating mechanism 110 with a handle 111 is arranged. At the left side of the rotating mechanism 110, a movable member 112 which has one end engaged into a recess of the rotating mechanism 110 is arranged. Also, at the left side of the rotating mechanism 110, a latching mechanism 115 is arranged with a recess in the middle thereof. A coil spring 114 is provided with one end secured to the movable member 112 and the other end to the rotating mechanism 110 to restrain the movable member 112 to the recess of the rotating mechanism 110. The latching mechanism 115 is pivotally coupled into a keeper pin 103 integrally formed with the housing 101 at the upper end thereof, and defines a catch 116 at the lower end thereof. The catch 116 is inserted into a slot of an armature 140 shown in more detail in FIG. 5, which is placed under the catch 116 and latches onto the inserted catch 116.

The movable member 112 has a movable contact 113 at the free end, which is butted into a stationary contact 156. The stationary contact 156 is provided to the second power terminal 155 which is arranged in the upper left side of the housing 101. These contacts 113, 156 are made with a material which has good electric conductivity together with sufficient strength to withstand frequent contact and separation therebetween. Examples of the material include silver, tungsten, silver-tungsten alloy, silver-cadmium alloy, sintered alloy thereof, carbon sintered alloy thereof, and etc. The contacts made of these materials are fixed to the movable member 112 and the second power terminal 155 by way of a suitable operation such as spotting or riveting.

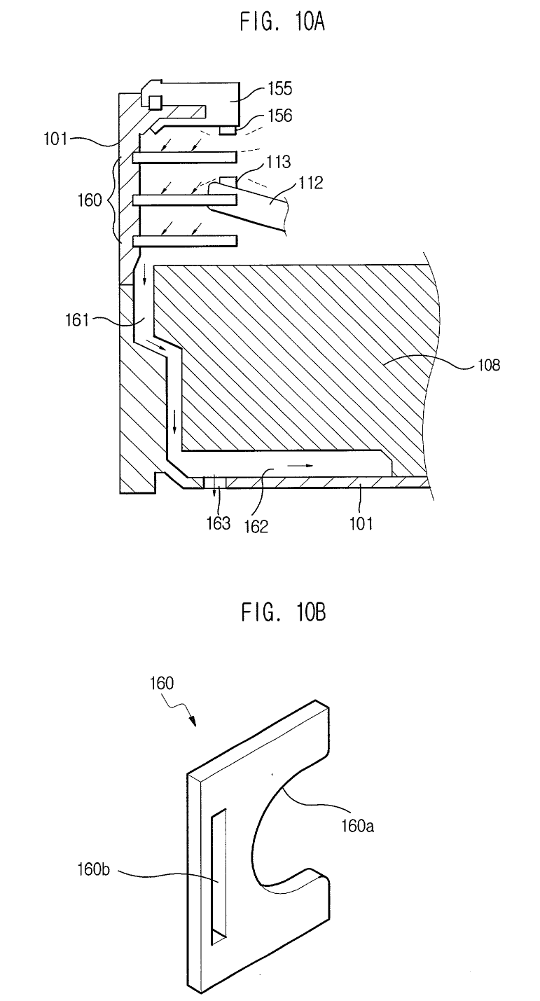

Under the second power terminal 155, three grids are arranged which will be described in detail later with reference to FIG. 10A and FIG. 10B.

Under the armature 140 in the lower part of the housing 101, a bimetal 120 is arranged which is surrounded in part with a magnetic yoke 121. The bimetal 120 has a free end 120a attached with a wire 105a which electrically connects the bimetal 120 to the foregoing movable member 112. The bimetal 120 has a stationary end 120b opposed to the free end 120a, which is fixed to a connecting member 123 via riveting or spotting. The connecting member 123 has the shape of r and fixed to the housing via a screw 124. The connecting member 123 is attached with a wire 105b which is connected to another contact 106 in the side of the first power terminal 150. Therefore, the bimetal 120 is electrically connected to the second power terminal 155 via the wire 105a, the movable member 112 and the contacts 113, 156 in the free end 120a side, and to the first power terminal 150 via the connecting member 123, the wire 105b and the contact 106 in the side of the stationary end 120b.

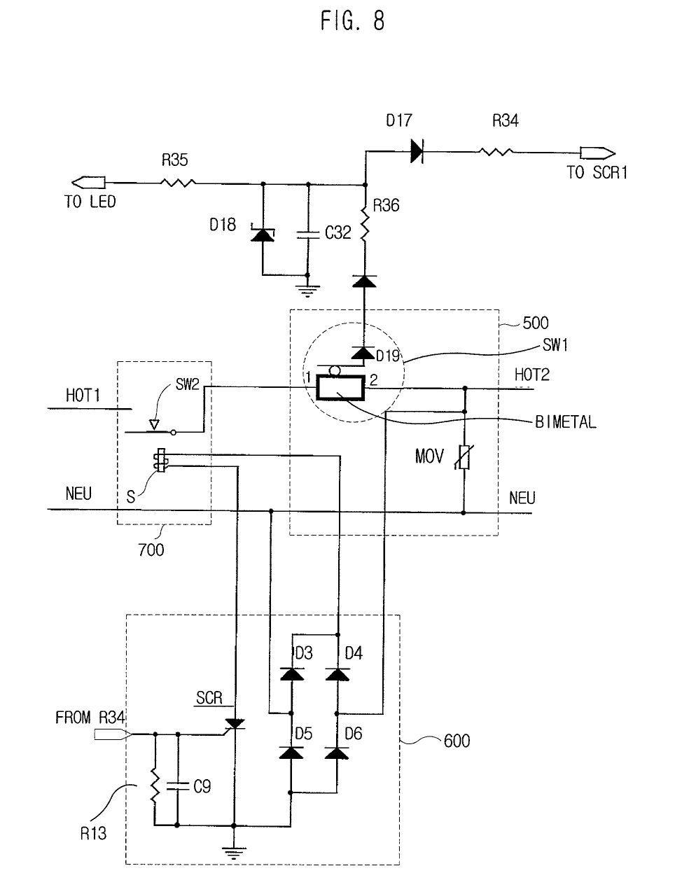

A calibration plate 130 is arranged under the free end 120a of the bimetal 120 with a predetermined distance. The calibration plate 130 is supported by a sensitive screw 131 which is shown only in part since covered with a screw cover 132. Also, the calibration plate 130 is electrically connected to a SCR, i.e. semiconductor controlled rectifier, which is arranged on a circuit board 107 and shown in FIG. 8.

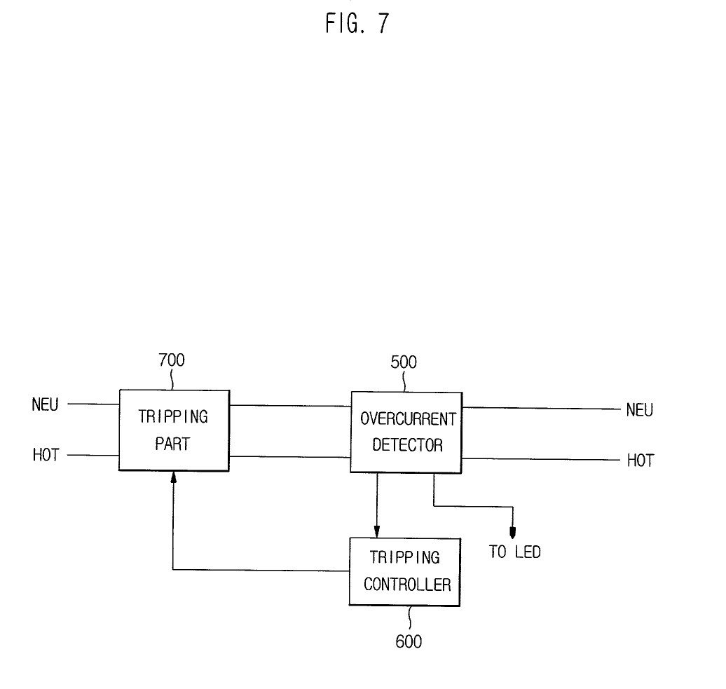

The SCR is connected to a solenoid 133 and a ground terminal via the circuit board 107. The solenoid 133 is arranged in the lower central part of the drawing and the ground terminal is not shown since it is arranged under the first power terminal 150. Solenoid 133 is connected to the first power terminal 150 and the SCR via the circuit board 107. Therefore, it can be understood that the first power terminal 150, the solenoid 133, the SCR and the ground terminal are connected via the circuit board 107. The electrically connected relation of these elements arranged in the circuit board 107 will be described in detail later with reference to FIG. 7 and FIG. 8.

In general, the SCR controls input and output of load according to a signal voltage applied to a gate terminal. Herein, the signal voltage means a voltage applied to the calibration plate 130. Therefore, when the bimetal 120 bends by the heat generated from any overcurrent flowing through the circuit breaker 100 which exceeds a rated value thereby causing the free end 120a of the bimetal 120 to come in contact with the calibration plate 130, the SCR is applied with a signal voltage from the calibration plate 130 side and thus electrically connect the solenoid 133 and the ground terminal in response to the signal voltage. In this case, the solenoid 133 is connected to the SCR in one end and to the first power terminal 150 in the other terminal via the circuit board 107 so that electricity can be supplied to the solenoid 133. Therefore, the solenoid is in a parking position in the natural state, and in operating position when the SCR is operated and thus generates a magnetic force.

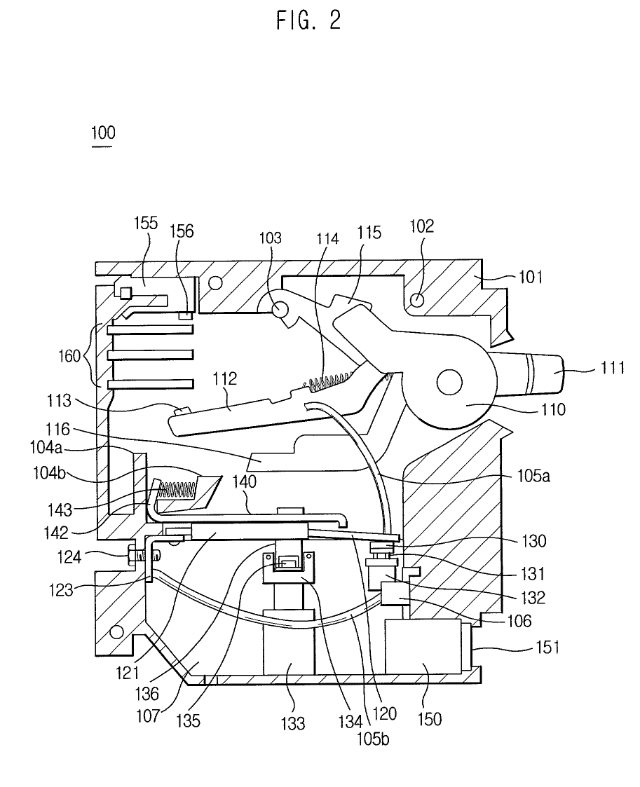

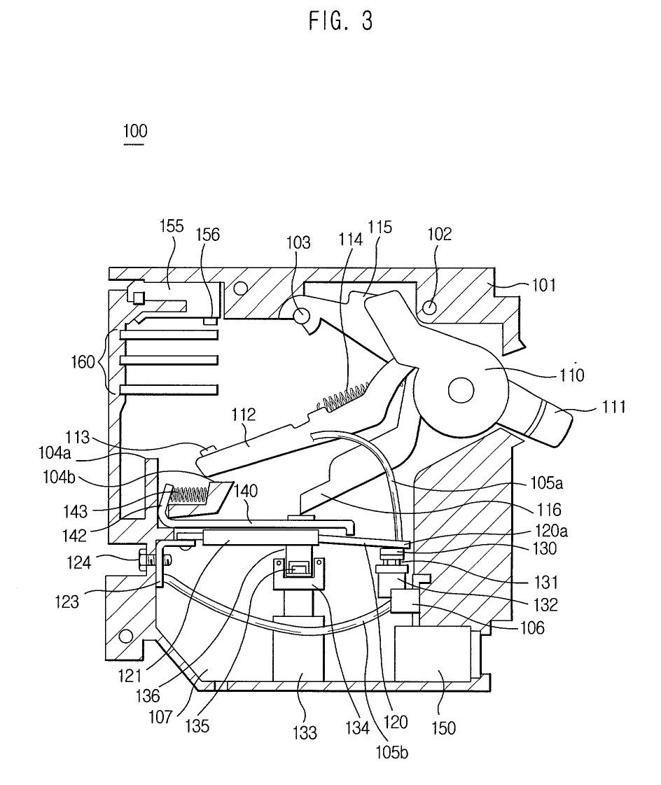

Time-lag tripping of the circuit breaker of the invention according to the operation of the solenoid 133 will be described hereinafter in the reference to FIG. 2 and FIG. 3.

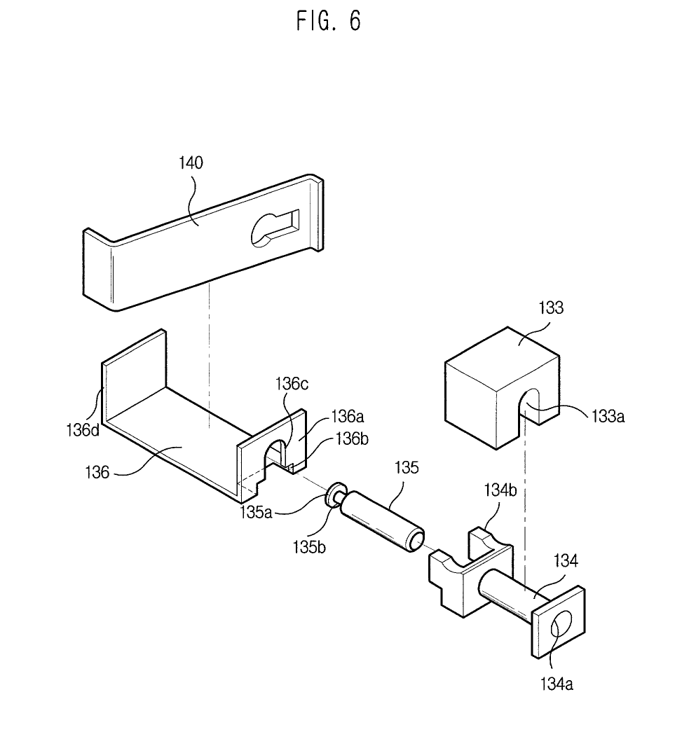

When the solenoid 133 generates a magnetic force, a plunger 135 is attracted and moved toward the solenoid 133 along a guide passage 134a which is shown in more detail in FIG. 6 as defined within a guide member 134. Then, the plunger 135 draws a trigger 136 engaged thereinto toward the solenoid 133. In this case, the trigger 136 which is also engaged into the armature 140 draws the armature 140 downward. Then, the armature 140 pivots clockwise thereby releasing the catch 116 of the latching mechanism 115 which is latched thereto. When the catch 116 is released from the armature 140, the latching mechanism 115 pivots clockwise about the upper end thereof which is coupled with the keeper pin 103, and thus the rotating mechanism 110 which is coupled with the latching mechanism 115 also pivots clockwise. Then, the coil spring 114 attached to the movable member 112 is applied with tension, and thus the movable member 112 is drawn downward. As a result, the movable member 112 rotates counter clockwise abruptly due to the elasticity of the coil spring 114 and thus the movable contact 113 is separated from the stationary contact 156. The time-lag tripping is carried out like this. Again, the latching mechanism 115 and the rotating mechanism 110 connected to the movable member 112 moves up to the position where the handle 111 is in a substantially horizontal position as shown in FIG. 2.

Then, as shown in FIG. 3, the movable member 112 further rotates counter clockwise due to the elasticity of the coil spring 114, the latching mechanism 115 rotates the reverse way instead to return to the original position, and the rotating mechanism 110 further rotates clockwise so that the handle 111 is oriented in the right downward direction.

Again, as shown in FIG. 2 and FIG. 3, when the movable contact 113 is separated from the stationary contact 156 and thus the electric circuit is interrupted, the solenoid 133 does not operate. Then, the magnetic force is not generated any longer and thus the attraction to the plunger 135 disappears. As a result, the drawing force of the plunger 135 to the armature 140 via the trigger 136 disappears also.

When the drawing force disappears, the armature is returned into the initial position by the return means.

The return means comprises a flange 142 formed at first end of the armature 140, a spring 143 pressing a first face of the flange 142, a first supporting member 104a provided adjacent to a second face of the flange 142 for supporting the flange 142 and a second supporting member provided beyond the spring 143 from the first face of the flange 142 to support the spring 143.

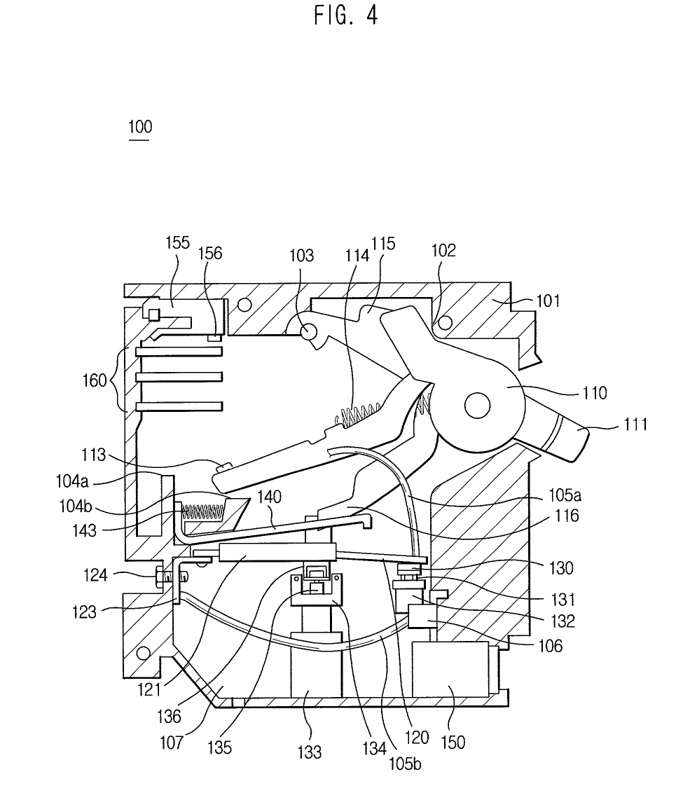

The armature 140 is provided with a flange 142 in the end remote from the slot 141. The flange 142 is supported in one face which is remote from the slot 141 by the first supporting member 104a. The flange 142 is supported in the other face adjacent to the slot 141 by a spring 143 which is supported by a second supporting member 104b. Then, the armature 140 is forced to pivot counter clockwise from the position parallel with the bimetal 120. As a result, when the solenoid 133 does not operate, the armature 140 pivots counter clockwise to return to its initial position as shown in FIG. 4, thereby gripping the catch 116 of the latching mechanism 115 again.

FIG. 5 is a perspective view of an armature and a latching mechanism in use for the circuit breaker of the invention.

The armature 140 has a slot 141 adjacent to one end, and a flange 142 at the other end. In the latching mechanism, only the catch 116 is shown. The catch 116 is gripped when inserted and engaged into the slot 141, thereby fixing the latching mechanism 115.

FIG. 6 is an exploded perspective view for illustrating relations among a solenoid, a trigger mechanism and an armature in use for the circuit breaker of the invention.

The solenoid 133 has a recess 133a which is adapted to receive the tubular body of the guide member 134 and surround the same. The guide member 134 has a guide passage 134a and 2 stop members 134b. The guide passage 134a is defined within the tubular body of guide member 134 and adapted for the plunger 135 to move through the same. The stoppers 134b are defined in the front part of the guide member 134 to be butted against a front flange 136a of the trigger 136 which is drawn by the plunger 135. When the plunger 135 is moved to a predetermined distance, the front flange 136a of the trigger 136 is blocked by the stoppers 134b and thus the trigger 136 is stopped from moving.

The plunger 135 has a head 135a and a neck 135b which has a smaller diameter than the head 135a. The trigger 136 has a first opening 136b defined in the front part of the base of the trigger 136 and in the lower part of the front flange 136a, and a second opening 136c continued from the first opening 136b and having a width which is narrower than the first opening 136b. Therefore, when the plunger 135 is moved with the head 135a beyond the flange 136a through the first opening 136b in the left direction and then upward, the neck 135b is fit in the second opening 136c. Then the plunger 135 and the trigger 136 engage to move together. Again, the trigger 136 has a rear flange 136d opposed to the front flange 136a. The trigger 136 can draw the armature 140 with the rear flange 136d.

FIG. 7 is a block diagram for illustrating a concept of the circuit breaker of the invention, and FIG. 8 is a circuit diagram of the circuit breaker of the invention.

Referring to FIG. 7, reference numeral 500 means an overcurrent detector which delects any overcurrent flow exceeding a predetermined rated value, 600 means a tripping controller responsive to a detecting signal from the overcurrent detector 500, and 700 means a tripping part for carrying out a tripping operation in response to a signal from the tripping controller 600.

The overcurrent detector 500 includes various electric components such as the foregoing bimetal 120 and calibration plate 130, the tripping controller 600 also includes various electric devices such as the foregoing SCR. The tripping part 700 includes the foregoing devices which actually perform tripping operation such as a solenoid 133, guide member 134, plunger 135, trigger 136, armature 140, latching mechanism 115, rotating mechanism 110, movable member 112 and etc.

Hereinafter, the tripping operation of the circuit breaker 100 of the invention will be described with reference to FIG. 7 and FIG. 8.

In FIG. 8, SW1 means a combination of devices such as the bimetal 120, the calibration plate 130 and a diode D19 of the overcurrent detector 500, and SW2 means a combination of the devices of the tripping part 700 with an exception to the solenoid S or 133.

In the case of rated current, the current flows between 2 power terminals HOT1, HOT2 via the SW2 and the bimetal of the SW1. But, when the overcurrent exceeding the rated value flows through the circuit, a portion of the current proceeds to the SCR of the tripping controller 600 via the foregoing devices in the SW1 such as the diode D19, a resistance R36, a diode D17 and a resistance R34 due to bending of the bimetal, thereby applying a signal voltage to the SCR. Then, the SCR electrically connects the solenoid S and a ground terminal NEU, and thus the solenoid S is magnetized. When the solenoid S is magnetized, the SW2 is tripped to interrupt any current between the 2 power terminals HOT1, HOT2.

In FIG. 8, the diode D19 is for rectifying any half wave from the SCR to the SW1, and the resistance R13 and a capacitor C9 are for preventing any erroneous operation of the SCR. At the right side of the SCR, 4 diodes D3, D4, D5 and D6 are arranged to rectify current flow.

When the overcurrent detector 500 detects any overcurrent, the signal or a portion of the current is also sent to an light emitting diode (LED) via D19, R36 and R35 to light the LED. Then, the user of the circuit breaker 100 of the invention can acknowledge that an overcurrent took place and thus the circuit breaker 100 carried out a time-lag tripping.

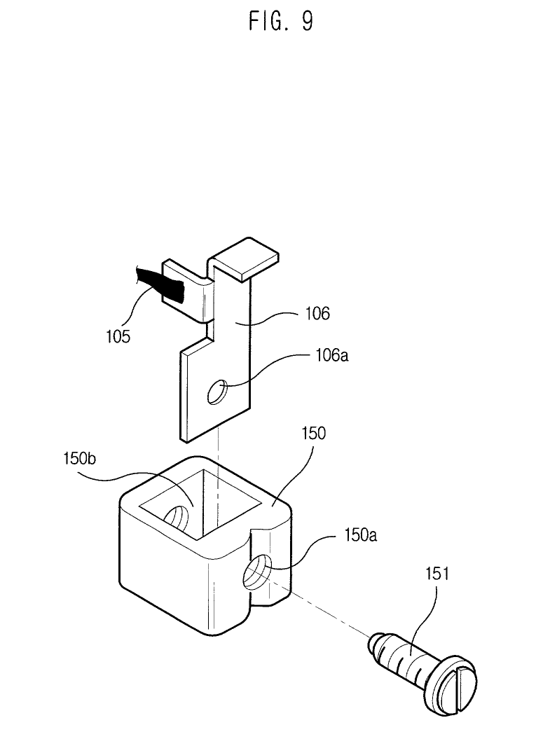

FIG. 9 is an exploded perspective view of a part of the circuit breaker shown in FIG. 1.

The first power terminal has a screw hole 150a which is screwed with a bolt 151. The contact 106 is inserted into an opening 150b of the first power terminal 150. The bolt 151 is inserted into the recess 106a of the contact 106 thus pressing the contact 106 against the inner wall of the first power terminal 150 to fix the same. Then, the outer power supply which is connected with the first power terminal 150 will be stably connected with the inner circuit of the circuit breaker 100 of the invention via the contact 106 and the wire 105b.

The bolt 151 is generally made with metal. But, in the invention, the bolt 151 can be made with an insulating polymer. It is preferred that the insulating polymer used for the bolt 151 of the invention has a melting point of about 200 to 400° C. and a Rockwell hardness of about 100 to 200. In this case, examples of the insulating polymer may include polyvinylchloride, polypropylene, polystyrene, polyvinylalcohol, polymethylmetaacrylrate, polyvinylidenechloride(PVC), celluloseacetate, cellulose-3-acetate acetylbutylcellulose, poly-4-methylphentene, polytrifluoroethylene, polytetrafluoroethylene copolymer, polychloroethylene, tetrachloroethylene-hexafluoropropylene copolymer, tetrafluoroethylene copolymer, polychloroethylene, tetrachloroethylenehexafluoropropylene, nylon 6, polyphenylideneoxide, polybutyleneterephtarate, polyethyleneterephtarate and polyolefin; compounds thereof; composites made with these resins; and etc.

FIG. 10A is a plane view for illustrating an arc quencher of the invention, and FIG. 10B is a perspective view of a grid in use for the arc quencher of the invention. Hereinafter, it will be described with reference to FIG. 10A together with FIG. 10B for the sake of brevity.

In FIG. 10A, a plurality of dotted lines around the contacts 112, 156 mean arc, which is generated when the contacts 112, 156 are separated, and arrows mean flow of the arc. The majority of the arc is absorbed by 3 metal grids 160. Then, the rest of the arc proceeds along an arc passage 161 defined between the housing 101 and a middle plate 108 and reaches a damping space 162, where the remaining arc is damped and extinguished. Therefore, a minute amount of the arc can be discharged from the circuit breaker 100 through an arc outlet 163. In this way, the arc is discharged only in a minute amount thereby preventing any probability of the arc induced fires.

The grids 160 are configured as a thin plate with a thickness of about 1 to 3 mm. Each of the grids 160 has a U-shaped indent 160a for providing a space adapted for the rotating member 112 to pivot, and a slit 160b for enlarging an absorbing area of arc. Each of the grids 160 is preferably distanced at about 2 to 4 mm from the next so that the arc can be properly absorbed and any arc induced deposition can be prevented from taking place at the same time.

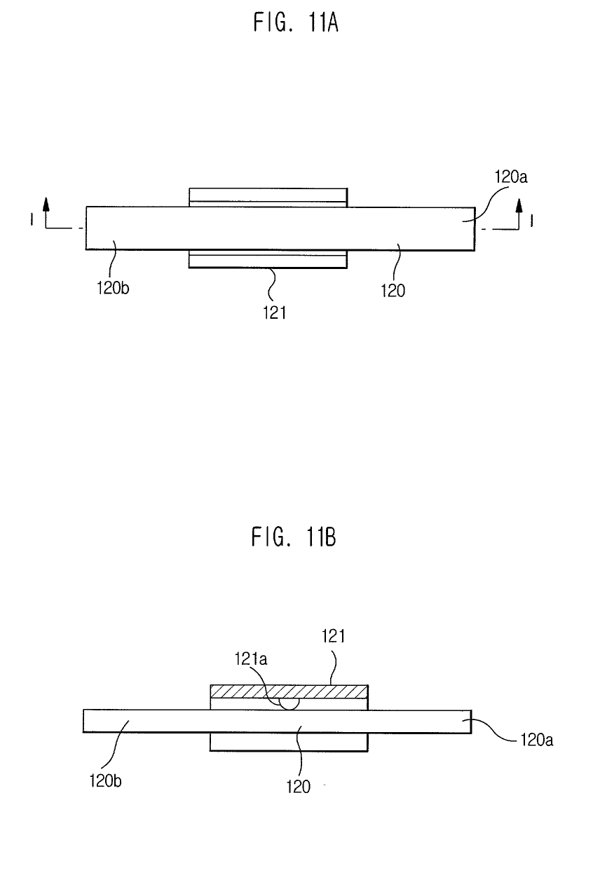

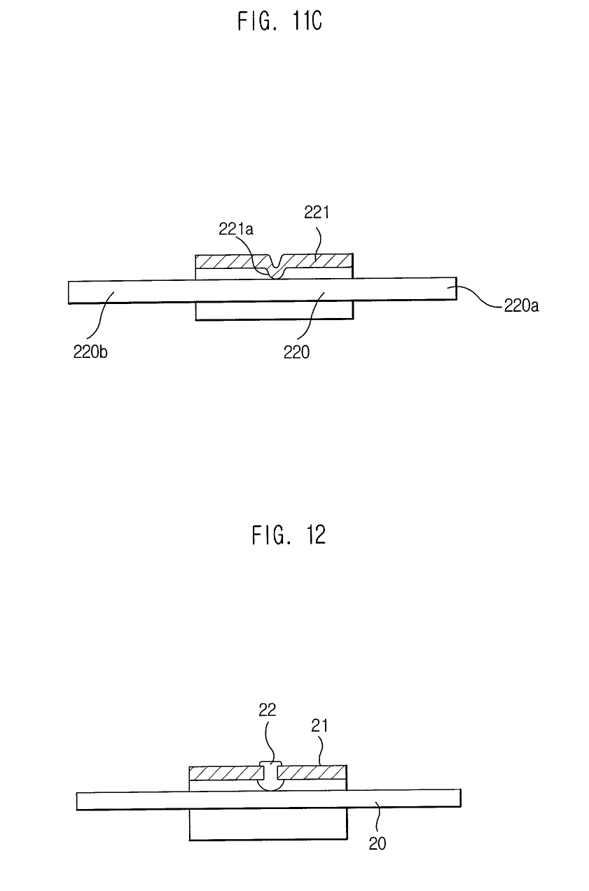

FIG. 11A is a bottom view of a bimetal-magnetic yoke assembly of the invention, FIG. 11B is a vertical sectional view taken in I-I line of FIG. 11A, FIG. 11C is a vertical sectional view similar to FIG. 11B, which is taken from another example of a bimetalmagnetic yoke assembly of the invention, and FIG. 12 is a vertical sectional view of a bimetal-magnetic yoke assembly of the prior art. Hereinafter, it will be described with reference to FIG. 11A to FIG. 12 together for the sake of brevity.

First, referring to FIG. 1 to FIG. 4 again, the magnetic yoke 121 is arranged around the bimetal 120 under the armature 140. As soon as an instantaneous overcurrent is induced by a phase-to-phase short in a current circuit, the magnetic yoke 121 is magnetized and thus draws the armature 140 from above. Then the latching mechanism 115, the rotating member 112 and etc. cooperate to carry out tripping operation, thereby interrupting the current circuit. In this way, when an instantaneous overcurrent takes place, an instantaneous tripping is carried out without passing any time-lag tripping which requires a long time for interruption of the circuit.

Referring to FIG. 12, a magnetic yoke 21 of the prior art is perforated in the upper plane, and then a rivet 22 is inserted into the perforated part of the magnetic yoke 21 so that the magnetic yoke 21 can be attached around a bimetal 20.

However, in the invention, the upper plane of the magnetic yoke 121 is impressed onto the bimetal 120 via pressing or punching in order to form a projection 121a which contacts the bimetal as shown in FIG. 11B. Then, the projection 121a is spotted and fixed to the bimetal 120 so that the magnetic yoke 121 can be fixedly attached around the bimetal 120.

Again, in FIG. 11C, the upper plane of the magnetic yoke 221 can be provided with a projection 221a in the lower part by spotting without any punching or pressing. Then, the magnetic yoke 221 can be supported on the upper face of the bimetal 120 with the projection 221a.

According to the invention, the circuit breaker of the invention has a bimetal and an armature, which are provided separately so that the detection of any overcurrent, tripping control and tripping operation can be carried out electro-magnetically in a tripping of a circuit.

Therefore, fabrication of the bimetal and the armature is easy and productivity in fabrication of the circuit breaker is increased. Also, a precise and rapid tripping can be carried out when overcurrents take place. Furthermore, time required for the time-lag tripping is reduced due to the rapid tripping and thus the degradation of a covering material can be reduced.

Hereinabove the invention has been described in reference to the preferred embodiment, but various other modifications and variations will be apparent to those skilled in the art without departing from the scope and spirit of the present invention as defined in the appended claims.

What is claimed is:

1. A circuit breaker for interrupting an electric circuit in detection of an overcurrent exceeding a rated value, said circuit breaker comprising:
detection means for detecting thee flow of an overcurrent exceeding a predetermined rated value in said electric circuit by the bending of a bimetal and for creating a detection signal;
control means for sending a tripping signal in response to the detection signal from said detection means; and
trip means being electro-magnetically operated in response to the tripping signal from said control means to interrupt said electric circuit.

2. The circuit breaker according to claim 1, wherein said trip means further comprising:
(i) a stationary contact;
(ii) rotation means provided with a movable contact which can be butted with said stationary contact;
(iii) latch means engaged into said rotation means for rotating said rotation means;
(iv) an armature for gripping said latch means;
(v) a solenoid being operated in response to the tripping signal from said control means; and
(vi) trigger means detachably engaged into said armature for drawing said armature in response to the operation of said solenoid.

3. The circuit breaker according to claim 2, wherein said armature and said bimetal are separated.

4. The circuit breaker according to claim 3, wherein said trip means further comprising return means for returning said armature which is drawn by said trigger means into the initial position.

5. The circuit breaker according to claim 4, wherein said return means further comprising:
(i) a flange projected from first end of said armature which is remote from the gripping part of said latch means;
(ii) a coil spring pressing a first face of said flange;
(iii) a first supporting member provided adjacent to a second face of said flange for supporting said flange; and
(iv) a second supporting member provided beyond said coil spring from said first face of said flange to support said coil spring.

6. The circuit breaker according to claim 2, wherein said trigger means further comprising:
(i) a trigger detachably engaged into said armature;
(ii) a plunger attracted by said solenoid for dragging said trigger toward said solenoid; and
(iii) a guide member defined with a passage hole adapted for said plunger to move through.

7. The circuit breaker according to claim 1, wherein said detection means further comprising:
(i) a calibration plate for contacting said bent bimetal and sending the signal from said bimetal to said control means; and
(ii) a half wave rectification device for rectifying a half wave from said control means to said calibration plate.

8. The circuit breaker according to claim 1, wherein said control means comprises a semiconductor controlled rectifier.

9. The circuit breaker according to claim 8, wherein said control means further comprises at least one resistance and at least one capacitor for preventing erroneous operation of said semiconductor controlled rectifier.

10. The circuit breaker according to claim 1, further comprising a half wave rectification device for rectifying a half wave from said control means to said detection means.

11. The circuit breaker according to claim 1, further comprising a light emitting diode for lighting in response to the detection signal generated by said detection means.

12. The circuit breaker according to claim 1, further comprising a magnetic yoke provided around said bimetal, wherein said magnetic yoke has projection which is projected to said bimetal in the middle of said magnetic yoke by punching, then fixed to said bimetal by spotting.

13. The circuit breaker according to claim 1, further comprising power terminals and ground terminals, at least one of said terminals having a bolt made with an insulating polymer for connecting said terminals to outer power supply.

14. The circuit breaker according to claim 13, wherein said insulating polymer has a melting point of about 200 to about 400° C.

15. The circuit breaker according to claim 13, wherein said insulating polymer has a Rockwell hardness of about 100 to about 200.

16. A circuit breaker for interrupting an electric circuit in detection of an overcurrent exceeding a rated value, said circuit breaker comprising:
(i) power terminals having a stationary contact;
(ii) detection means for detecting the flow of overcurrent exceeding a predetermined rated value in said electric circuit by the bending of a bimetal and for creating a detection signal;
(iii) control means for sending a tripping signal in response to the detection signal from said detection means; and
(iv) trip means being electro-magnetically operated in response to the tripping signal from said control means to interrupt said electric circuit and having rotation means provided with a movable contact which can be butted with said stationary contact.

17. The circuit breaker according to claim 16, wherein said contact is composed of one selected from the group consisting of silver, tungsten, silver-tungsten alloy and silver-tungsten alloy.

18. A circuit breaker for interrupting an electric circuit in detection of an overcurrent exceeding a rated value, said circuit breaker comprising:
(i) power terminals having a stationary contact;
(ii) detection means for detecting the flow of overcurrent exceeding a predetermined rated value in said electric circuit by the bending of a bimetal and for creating a detection signal;
(iii) control means for sending a tripping signal in response to the detection signal from said detection means;
(iv) trip means being electro-magnetically operated in response to the tripping signal from said control means to interrupt said electric circuit and having rotation means provided with a movable contact which can be butted with said stationary contact; and
(v) an arc quencher for extinguishing arc generated from said contacts.

19. The circuit breaker according to claim 18, wherein said arc quencher further comprising:
(i) a plurality of metal grids arranged around said movable contact in the position butted with said stationary contact for absorbing the generated arc;
(ii) a damping space for extinguishing the rest of the arc by damping after said metal grids absorb the generated arc; and
(iii) an arc outlet for discharging the remaining arc which is not absorbed or extinguished.

20. A circuit breaker for interrupting an electric circuit in detection of an overcurrent exceeding a rated value, said circuit breaker comprising:
(i) detection means for detecting the flow of overcurrent exceeding a predetermined rated value in said electric circuit by the bending of a bimetal and for creating a detection signal;
(ii) control means for sending a tripping signal in response to the detection signal from said detection means;
(iii) trip means being electro-magnetically operated in response to the tripping signal from said control means to interrupt said electric circuit, wherein said trip means comprises (a) a stationary contact, (b) a rotating member having a movable contact detachably butted with said stationary contact, (c) latch means engaged into said rotating member for rotating said rotating member, and (d) an armature for gripping said latch means; and
(iv) a light emitting diode for lighting in response to the detection signal generated by said detection means.

21. The circuit breaker according to claim 20, wherein said trip means further comprising:
(i) a solenoid being operated in response to the tripping signal from said control means; and
(ii) trigger means detachably engaged into said armature for drawing said armature in response to the operation of said solenoid.

22. The circuit breaker according to claim 21, wherein said trigger means further comprising:
a trigger which can be engaged into said armature;
a plunger which can be attracted by said solenoid for dragging said trigger toward said solenoid; and
a guide member defined with a passage hole adapted for said plunger to move through.

23. The circuit breaker according to claim 21, further comprising return means for returning said armature which is drawn by said trigger means into the initial position, said return means comprising:
(i) a flange formed at first end of said armature which is remote from the gripping part of said latch means;
(ii) a coil spring pressing a first face of said flange;
(iii) a first supporting member provided adjacent to a second face of said flange for supporting said flange; and
(iv) a second supporting member provided beyond said coil spring from said first face of said flange to support said coil spring.

24. The circuit breaker according to claim 20, wherein said detection means further comprising:
(i) a calibration plate for contacting said bent bimetal and sending the signal from said bimetal to said control means; and
(ii) a half wave rectification device for rectifying a half wave from said control means to said calibration plate.

25. The circuit breaker according to claim 20, further comprising a magnetic yoke provided around said bimetal, wherein said magnetic yoke has a projection which is projected to said bimetal in the middle of said magnetic yoke by punching, then fixed to said bimetal by spotting.

26. The circuit breaker according to claim 20, further comprising power terminals and ground terminals, at least one of said terminals having a bolt made with an insulating polymer for connecting said terminals to outer power supply.
